(19) United States
(12) Patent Application Publication
(10) Pub. No.: US 2009/0322929 A1
(43) Pub. Date: Dec. 31, 2009

(54) COMPACT CAMERA MODULE

(75) Inventor: STEVEN WEBSTER, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/329,616

(22) Filed: Dec. 7, 2008

(30) Foreign Application Priority Data
Jun. 30, 2008 (CN) 200810302446.4

(51) Int. Cl. H04N 5/225

(52) U.S. Cl. 348/340; 348/E05.024

(57) ABSTRACT

A camera module includes an image sensor package and a lens module. The image sensor package includes a base having an interior surface and an opposite exterior surface, an image sensor, a carrier plate and a plurality of passive elements. A cavity is defined on the interior surface of the base. The image sensor chip having a sensitive region is received in the cavity of the base and is electrically connected to the base. The carrier plate, comprising a light transparent area and an electrode area surrounding the transparent area, is formed on the base. A plurality of electrodes attached on the electrode area of the carrier plate and electrically connected to the base. The passive elements are mechanically and electrically attached on the electrode area of the carrier plate. The lens module is attached on the carrier plate for receiving the passive elements therein.

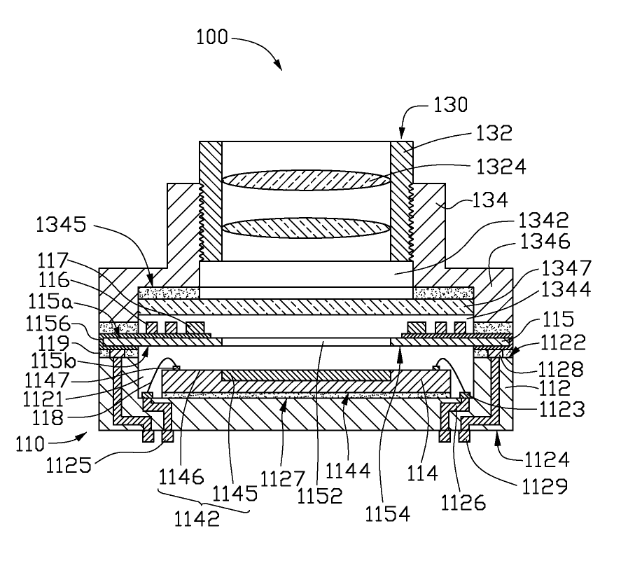

### BACKGROUND

1. Technical Field

The present invention generally relates to camera modules and, more particularly, to a compact camera module.

2. Description of the Related Art

Image sensors are essential components that have been widely used in camera modules. Generally, to allow an image sensor to operate, some peripheral electronic components associated with the image sensor are often used together with the image sensor. For example, a passive component is combined to filter output signals from the image sensor for improving the imaging performance and eliminating the crosstalk noise which occurs during signal switching and transmission.

A typical camera module includes a substrate, an image sensor chip and several passive components, and a lens assembly. The image sensor chip and the passive components are both disposed on the substrate and electrically connected to the substrate. The lens assembly is mounted on the substrate and together with the substrate to form a receiving space for receiving the image sensor chip and the passive components therein and protecting them from being impacted by exterior circumstance. However, certain amount of surface of the substrate is normally required to accommodate both the passive components and the image sensor chip. Therefore, the substrate must be big enough for mounting the image sensor chip and the passive components thereon. This structure of the camera module above mentioned conflicts with the tendency for miniaturization of the camera module and the electronic products with the same.

Therefore, a compact camera module is desired.

### BRIEF DESCRIPTION OF THE DRAWINGS

The drawing is a schematic, cross-sectional view of a camera module, according to an exemplary embodiment.

### DETAILED DESCRIPTION OF THE PREFERRED EMBODIMENTS

Referring to the drawing, a camera module 100, according to an exemplary embodiment, includes an image sensor package 110 and a lens module 130. The image sensor package 110 assembles with the lens module 130 and accurately aligns with a light axis of the lens module 130.

The image sensor package 110 includes a base 112, an image sensor chip 114, a carrier plate 115, a number of passive elements 116 and a number of active elements 117.

The base 112, may be made of ceramic, glass, plastic, laminate or any other suitable material. The base 112 is configured for supporting the image sensor chip 114. The base 112 includes an interior surface 1122 and an opposite exterior surface 1124. A cavity 1121 is defined on the interior surface 1122 of the base 112 for receiving the image sensor chip 114. A number of input terminals 1123 and corresponding number of first output terminals 1125 are respectively formed on the bottom 1127 of the cavity 1121 and the exterior surface 1124 of the base 112. The input terminals 1123 are electrically coupled to the first output terminals 1125 respectively by a number of inner circuits 1126 embedded in the base 112. The input terminals 1123 is configured for electrically coupling to the image sensor chip 114 to transmit the electronic signals outputted from the image sensor chip 114 to the first output terminals 1125. The first output terminals 1125 are configured for transmitting the electronic signals transmitted from the input terminals 1123 to another peripheral electronic equipments to process. A number of conductive fingers 1128 and a number of second output terminals 1129 electrically connected with the corresponding conductive fingers 1128 via a number of circuits embedded in the base 112, are separately installed on the interior surface 1122 and the exterior surface 1124 of the base 112.

The image sensor chip 114 is a photosensitive element responsive to infrared radiation, ultraviolet radiation, and visible light beams and used to transform light signals into electronic signals. The image sensor chip 114 includes an upper surface 1142 and an opposite lower surface 1144. The upper surface 1142 of the image sensor chip 114 includes a sensitive region 1145 and a non-sensitive region 1146 surrounding the sensitive region 1145. A number of bonding pads 1147 are formed on the non-sensitive region 1146 of the image sensor chip 114 with a space between each other. The image sensor chip 114 is received in the cavity 1121 of the base 112, and mounted on the bottom 1127 of the cavity 1121 via adhesive 119. Each one of bonding pads 1147 of the image sensor chip 114 is electrically connected to the corresponding input terminal 1123 of the base 112 via a wire 118 by wire bonding technology.

The carrier plate 115 is mounted on the interior surface 1122 by the adhesive 119 and configured for supporting the passive elements 116 and the active elements 117. The carrier plate 115 includes a top surface 115a and an opposite bottom surface 115b. The carrier plate 115 includes a light transparent area 1152 corresponding to the sensitive region 1145 of the image sensor chip 114 and an electrode area 1154 surrounding the light transparent area 1152. A number of electrodes 1156 are attached on the electrode area 1154 and configured for electrically connecting to the corresponding conductive fingers 1128 of the base 112. The light transparent area 1152 of the carrier plate 115 is substantially aligned with the sensitive region 1145 of the image sensor chip 114, and the light transparent area 1152 is equal to or larger than the sensitive region 1145 of the image sensor chip 114 so that the sensitive region 1145 can be well exposed to a beam of incident light from outside of the camera module 100. The light transparent area 1152 may be made of a transparent material such as glass, quartz and so on. Alternatively, the transparent area 1152 also can be designed as a hole that runs through the top and bottom surfaces 115a, 115b of the carrier plate 115 for exposing the sensitive region 1145 of the image sensor chip 114.

The passive elements 116 such as inductor, capacitor or resistor, etc., are generally used for improving the transmission quality of image signals outputted from the image sensor chip 114. The passive elements 116 each having a number of electrodes formed thereon are positioned on the electrode area 1154 of carrier plate 115, and are electrically connected to the electrodes 1156.

The active elements 117, such as processing chip, driving chip, etc., are generally used for processing the signals of image sensor chip 114. The active elements 117 are positioned on the electrode area 1154 of carrier plate 115, and electrically connected to the electrodes 1156.

The lens module 130 includes a lens barrel 132 and a lens holder 134. The lens barrier 132 is a hollow cylinder with at least one lens 1324 received therein for light passing therethrough. One end of the lens barrel 132 is received in the lens holder 134. The lens holder 134 is a stepped hollow cylinder, which includes a first receiving portion 1342 and a second receiving portion 1344 directly extending from the first receiving portion 1342. The diameter of the first receiving portion 1342 is smaller than that of the second receiving portion 1344, therewith, a flange portion 1345 is formed between the first and second receiving portion 1342, 1344. A transparent cover 1347 is mounted on the inner side of the flange portion 1345 for keeping the first receiving portion 1342 and the second receiving portion 1344 isolated from each other. The lens holder 134 is attached on the top surface 115a of the plate 115 via the end of the second receiving portion 1344. It is understandable that the diameter of the first receiving portion 1342 and the second receiving portion 1344 of the lens holder 134 can vary according to the actual need, for example, the former can be larger than the latter or equal with each other.

In the present invention of camera module 100, the base 112 is configured for receiving an image sensor chip 112, the passive elements 116 and the active elements 117 are supported by the carrier plate 115 over the image sensor chip 112. Therefore, the size of the base 112 can be reduced, accordingly the whole camera module 100 using the base 112 can be miniaturized.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A camera module comprising:
an image sensor package comprising:
a base including an interior surface with a cavity defined thereon, and an opposite exterior surface;
a plurality of input terminals formed on a bottom of the cavity, and a plurality of conductive fingers mounted on the interior surface of the base;
a plurality of output terminals mounted on the exterior surface of the base and electrically connected to the corresponding input terminals or the corresponding conductive fingers;
an image sensor chip received in the cavity of the base and electrically connected to the input terminals of base, the image sensor chip comprising a sensitive region and a non-sensitive region surrounding the sensitive region;
a carrier plate mounted on the interior surface of the base, and comprising a light passing area corresponding to the sensitive region of the image sensor chip and an electrode area surrounding the transparent area;
a plurality of electrodes attached on the electrode area of the carrier plate and electrically connected to the corresponding conductive fingers; and
a plurality of passive elements attached on the electrode area of the carrier plate and electrically connected to the electrodes on the electrode area; and
a lens module comprising a lens barrel and a lens holder holding the lens barrel therein, the lens holder attached on the carrier plate.

2. The camera module as claimed in claim 1, further comprising an active element mounted on the electrode area of the carrier plate and electrically connected to the corresponding electrodes on the electrode area.

3. The camera module as claimed in claim 1, wherein the area of the light transparent area of the carrier plate is equal to or larger than that of the sensitive region of the image sensor chip.

4. The camera module as claimed in claim 3, wherein the light transparent area is made of a transparent material.

5. The camera module as claimed in claim 4, wherein the transparent material is selected from the group consisting of glass and quartz.

6. The camera module as claimed in claim 3, wherein the light transparent area is a hole defined running through the upper and lower surfaces of the carrier plate.

7. The camera module as claimed in claim 1, wherein the lens holder is a step-shaped hollow cylinder, which comprises a first receiving portion and a second receiving portion directly extending from the first receiving portion, the lens holder is mounted on the top surface of the carrier plate by an end of the second receiving portion.

8. The camera module as claimed in claim 7, wherein the diameter of the first receiving portion is smaller than that of the second receiving portion, and a flange portion is formed between the first receiving portion and the second receiving portion.

9. The camera module as claimed in claim 8, wherein a transparent cover is mounted on the flange portion for keeping the first receiving portion and the second portion isolated from each other.

10. A camera module comprising:
a base defining a cavity thereon;
an image sensor chip received in the cavity of the base and electrically connected to the base, the image sensor chip comprising a sensitive region and a non-sensitive region surrounding the sensitive region;
a carrier plate disposed on the base to cover the cavity of the base; the carrier plate defining a first portion and a second portion, the first portion being able to let light pass through and substantially aligned with the sensitive region of the image sensor chip;
a plurality of passive elements attached on the second portion of the carrier plate and electrically connected to the base; and
a lens module attached on the carrier plate and received the passive elements therein.

11. The camera module as claimed in claim 10, wherein the area of the first portion of the carrier plate is equal to or larger than that of the sensitive region of the image sensor chip.

12. The camera module as claimed in claim 11, wherein the first portion of the carrier plate is made of a transparent material.

13. The camera module as claimed in claim 12, wherein the transparent material is selected from the group consisting of glass and quartz.

14. The camera module as claimed in claim 11, wherein the first portion of the carrier plate is a hole defined running through the carrier plate.

15. The camera module as claimed in claim 10, wherein the second portion of the carrier plate is defined surrounding the first portion of the carrier plate.

16. The camera module as claimed in claim 10, further comprising a plurality of electrodes formed on the second portion of the carrier plate and configured for electrically connecting the passive elements to the base.

17. An image sensor package comprising:
a base including an interior surface and an opposite exterior surface, the base defined a cavity on the interior surface;
an image sensor chip received in the cavity of the base and electrically connected to the base, the image sensor chip comprising a sensitive region and a non-sensitive region;
a carrier plate disposed on the interior surface of the base to seal the cavity of the base; the carrier plate comprising a first portion which is able to let light pass through and substantially aligned with the sensitive region of the image sensor chip and a second portion; and
a plurality of passive elements attached on the second portion of the carrier plate and electrically connected to base.

18. The image sensor package as claimed in claim 17, wherein the area of the first portion of the carrier plate is equal to or larger than that of the sensitive region of the image sensor chip.

19. The image sensor package as claimed in claim 18, wherein the first portion is made of a transparent material.

20. The image sensor package as claimed in claim 18, wherein the first portion is a hole defined running through the carrier plate.
